(19) United States
(12) Patent Application Publication
(10) Pub. No.: US 2015/0281050 A1
(43) Pub. Date: Oct. 1, 2015

(54) Method for Adjacency Status Synchronization in Label Distribution Protocol

(71) Applicant: Alcatel-Lucent USA Inc., Murray Hill, NJ (US)

(72) Inventor: Pranjal Dutta, Sunnyvale, CA (US)

(73) Assignee: Alcatel-Lucent USA Inc., Murray Hill, NJ (US)

(21) Appl. No.: 14/230,884

(22) Filed: Mar. 31, 2014

(51) Int. Cl. H04L 12/723; H04L 12/751; H04L 12/741

(52) U.S. Cl. CPC H04L 45/50; H04L 45/74; H04L 45/026

(57) ABSTRACT

A method for providing LDP Hello Adjacency status synchronization between peers is disclosed. The method for providing LDP Hello Adjacency status synchronization between peers includes generating, by a first packet-switched network node, a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status; and transmitting, by the first packet-switched network node, the Hello Adjacency Status TLV to a second packet-switched network node. The method for providing LDP Hello Adjacency status synchronization between peers provides recovery advantages over systems known in the art by providing capability for a peer to receive information on the loss of Hello Adjacency from another peer.

### FIELD OF THE INVENTION

The invention relates to hello adjacencies in data networks, and in particular to synchronization of hello adjacency status between two peers sharing an LDP session when one peer discovers a loss before the other.

### BACKGROUND OF THE INVENTION

Label Distribution Protocol (LDP) is a protocol used to distribute labels in non-traffic-engineered applications. LDP allows routers to establish label switched paths (LSPs) through a network by mapping network-layer routing information directly to data link layer-switched paths.

An LSP is defined by the set of labels from the ingress Label Switching Router (LSR) to the egress LSR. LDP associates a Forwarding Equivalence Class (FEC) with each LSP it creates. A FEC is a collection of common actions associated with a class of packets. When an LSR assigns a label to a FEC, it must let other LSRs in the path know about the label. LDP helps to establish the LSP by providing a set of procedures that LSRs can use to distribute labels.

The FEC associated with an LSP specifies which packets are mapped to that LSP. LSPs are extended through a network as each LSR splices incoming labels for a FEC to the outgoing label assigned to the next hop for the given FEC. The next-hop for a FEC prefix is resolved in the routing table.

LDP allows an LSR to request a label from a downstream LSR so it can bind the label to a specific FEC. The downstream LSR responds to the request from the upstream LSR by sending the requested label.

In MPLS environments where LDP performs the label distribution the LDP operation begins with a hello discovery process to find LDP peers in the network. LDP peers are two LSRs that use LDP to exchange label/FEC mapping information. An LDP session is created between LDP peers. A single LDP session allows each peer to learn the other's label mappings (LDP is bi-directional) and to exchange label binding information.

LDP signaling works with the MPLS label manager to manage the relationships between labels and the corresponding FEC.

An MPLS label identifies a set of actions that the forwarding plane performs on an incoming packet before discarding it. The FEC is identified through the signaling protocol (in this case, LDP) and allocated a label. The mapping between the label and the FEC is communicated to the forwarding plane. In order for this processing on the packet to occur at high speeds, optimized tables are maintained in the forwarding plane that enable fast access and packet identification.

When an unlabeled packet ingresses the router, classification policies associate it with a FEC. The appropriate label is imposed on the packet, and the packet is forwarded. Other actions that can take place before a packet is forwarded are imposing additional labels, other encapsulations, learning actions, etc. When all actions associated with the packet are completed, the packet is forwarded.

When a labeled packet ingresses the router, the label or stack of labels indicates the set of actions associated with the FEC for that label or label stack. The actions are preformed on the packet and then the packet is forwarded.

An LDP Label Switched Router (LSR) periodically multicasts User Datagram Protocol (UDP) based hellos on configured links as “discovery protocol” in order to establish Transmission Control Protocol (TCP) based protocol sessions with prospective peers over that link. In LDP it is possible that there can be multiple hello adjacencies associated with a TCP based peering session between router peers A and B. For example, there can be multiple parallel links between two LDP peers and thus a hello adjacency is formed on each link. Referring to FIG. 1, there may be seen Label Switched Router A (LSR_{A}) 102 and Label Switched Router B (LSR_{B}) 104 connected by three parallel links.

Additionally there can be a ‘targeted’ hello adjacency between the peers. In order to form targeted hello adjacency each peering LSR periodically unicasts hellos to each other. Such LSRs forming targeted adjacency can be directly connected as well as multiple hops away. Referring now to FIG. 2 there may be seen a network having three peering LSRs: LSR_{A} 202, LSR_{B} 204, and LSI % 206, connected by links. LSR_{A} 202 is connected to LSR_{B} 204 by link hello adjacency, and LSR_{A} 202 is connected to LSR_{B} 204 by targeted hello adjacency through LSR_{C} 206.

Even though there could be multiple hello adjacencies between an LSR_{A} and LSR_{B}, it results in only one TCP based protocol session between them. The session is bootstrapped by the first hello adjacency formed between LSR_{A} and LSR_{B}, irrespective of the hello adjacency being a link type or a targeted type.

The protocol session between an LSR_{A} and LSR_{B} is brought down when there are no more hello adjacencies between them. Thus when a hello adjacency fails, the session remains operationally up if there are other active hello adjacencies between the peers. Label mapping exchange between two peers for certain LDP Forwarding Equivalence Classes (FECs) is dependent upon existence of hello adjacency types. For example, the FEC types applicable to link hello adjacency are withdrawn in the event of failure of the last link hello adjacency but the session will continue to exist due to targeted hello adjacency still alive.

When there are multiple hello adjacencies between two peering LSRs then detection of failure of a specific hello adjacency is asymmetric due to its connectionless mode of operation

A hello adjacency failure may be detected by peer LSR_{B} before it is detected by peer LSR_{A}. Thus LSR_{B} may initiate certain protocol actions for the failure before LSR_{A} as LSR_{A} is unaware of the loss of adjacency by peer LSR_{B} to peer LSR_{A}.

Asymmetric adjacency failure detection may happen for at least the following reasons:
Explicit shutdown of hello transmission by LSR_{B}.
There is no “external” method available at peer LSR_{A} to detect a remote failure of link at peer LSR_{B}.
An “external” method (such as Bidirectional Forwarding Detection (BFD) protocol) is available at peer LSR_{A} to detected a remote failure of a link at peer LSR_{B} but such detection (based in timed out) is slower than what is required by peer LSR_{A} to undertake appropriate responsive action such as, for example, diverting traffic to alternate links. This becomes even more of a concern when peer LSR_{A} has implemented Fast Re-Routing (FRR) techniques. FRR switchover time requirements could be as low as 3-5 ms.

Therefore, it would be useful to have a method which could allow for synchronization of hello adjacency status between two LDP peers using the operational LDP session.

### SUMMARY OF THE INVENTION

It is an object of the invention to provide a method which allows for synchronization of hello adjacency status between two LDP peers using the operation LDP session.

According to a first aspect of the invention there is provided a method of Label Distribution Protocol (LDP) Hello Adjacency status synchronization, the method having the steps of: generating, by a first packet-switched network node, a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV; and transmitting, by the first packet-switched network node, the Hello Adjacency Status TLV to a second packet-switched network node.

In some embodiments of this aspect of the invention the Hello Adjacency Status TLV is included within an LDP Hello Status message. In some of these embodiments, the LDP Hello Status message is sent from an ingress node to a transit node. In some of these embodiments the LDP Hello Status message is sent from a first transit node to a second transit node.

In other embodiments of this aspect of the invention the status data field further has an Adjacency Status Code field; a Sender Interface ID field; a Sender Sequence Number field; a Receiver Interface ID field; and a Receiver Sequence Number field. In some of these embodiments, the U bit has a value of one; and the F bit has a value of zero. In yet others of these embodiments, the Hello Adjacency Status TLV further has a Vendor_OUI field.

According to another aspect of the invention there is provided an apparatus for Label Distribution Protocol (LDP) Hello Adjacency status synchronization, the apparatus having: a processor; and tangible and non-transitory computer readable storage medium storing programming for execution by the processor, the programming including instructions to: communicate a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV.

In some embodiments of this aspect of the invention the Hello Adjacency Status TLV is included within an LDP Hello Status message. In some of these embodiments, the LDP Hello Status message is sent from an ingress node to a transit node. In some of these embodiments the LDP Hello Status message is sent from a first transit node to a second transit node.

In other embodiments of this aspect of the invention the status data field further has an Adjacency Status Code field; a Sender Interface ID field; a Sender Sequence Number field; a Receiver Interface ID field; and a Receiver Sequence Number field. In some of these embodiments, the U bit has a value of one; and the F bit has a value of zero. In yet others of these embodiments, the Hello Adjacency Status TLV further has a Vendor_OUI field.

According to another aspect of the invention there is provided a method for Label Distribution Protocol (LDP) Hello Adjacency status synchronization, the method having the steps of: receiving, a second packet-switched network node from by a first packet-switched network node, a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV; and decoding, by the second packet-switched network node, the Hello Adjacency status.

In some embodiments of this aspect of the invention the Hello Adjacency Status TLV is included within an LDP Hello Status message. In some of these embodiments, the LDP Hello Status message is received at a transit node from an ingress node. In some of these embodiments the LDP Hello Status message is received at a second transit node from a first transit node.

In other embodiments of this aspect of the invention the status data field further has an Adjacency Status Code field; a Sender Interface ID field; a Sender Sequence Number field; a Receiver Interface ID field; and a Receiver Sequence Number field. In some of these embodiments, the U bit has a value of one; and the F bit has a value of zero. In yet others of these embodiments, the Hello Adjacency Status TLV further has a Vendor_OUI field.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which like reference numbers are used to represent like elements, and:

FIG. 1 illustrates an exemplary pair of LSR peers connected by multiple links according to the prior art;

FIG. 2 illustrates an exemplary pair of LSR peers having link hello adjacency and targeted hello adjacency via another LSR peer, according an embodiment of the invention;

FIG. 3 is a diagram illustrating a LDP Interface Info Type Length Value (TLV) to be sent when exchanging Hello Messages according to an embodiment of the invention;

FIG. 4 is a diagram illustrating an Interface Info Type Length Value (TLV) in a LDP Hello Message according to an embodiment of the invention;

FIG. 5 is a diagram illustrating an Interface ID Sub-TLV according to an embodiment of the invention;

FIG. 6 is a diagram illustrating an Adjacency Status TLV according to an embodiment of the invention;

FIG. 7 is a diagram illustrating an LDP Notification Message for Hello Adjacency Status according to an embodiment of the invention; and

FIG. 8 depicts a high level block diagram of a computing device, such as a processor in a telecom network element, suitable for use in performing functions described herein.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such a feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

The techniques shown in the figures can be implemented using code and data stored and executed on one or more electronic devices (e.g., a network element). Such electronic devices store and communicate (internally and with other electronic devices over a network) code and data using machine-readable media, such as machine storage media (e.g., magnetic disks; optical disks; random access memory; read only memory; flash memory devices) and machine communication media (e.g., electrical, optical, acoustical or other form of propagated signals—such as carrier waves, infrared signals, digital signals, etc.). In addition, such electronic devices typically include a set of one or more processors coupled to one or more other components, such as a storage device, one or more user input/output devices (e.g., a keyboard and/or a display), and a network connection. The coupling of the set of processors and other components is typically through one or more busses and bridges (also termed as bus controllers). The storage device and signals carrying the network traffic respectively represent one or more machine storage media and machine communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software that communicatively interconnects other equipment on the network (e.g., other network elements, computer end stations, etc.). Customer computer end stations (e.g., workstations, laptops, palm tops, mobile phones, etc.) access content/services provided over the Internet and/or content/services provided on associated networks such as the Internet. The content and/or services are typically provided by one or more server computing end stations belonging to a service or content provider, and may include public webpages (free content, store fronts, search services, etc.), private webpages (e.g., username/password accessed webpages providing email services, etc.), corporate networks over VPNs, etc. Typically, customer computing end stations are coupled (e.g., through customer premise equipment coupled to an access network, wirelessly to an access network) to edge network elements, which are coupled through core network elements of the Internet to the server computing end stations.

In general in the description of the figures, like reference numbers are used to represent like elements.

Following are described two problem scenarios here that are addressed by embodiments of the invention.

Scenario 1

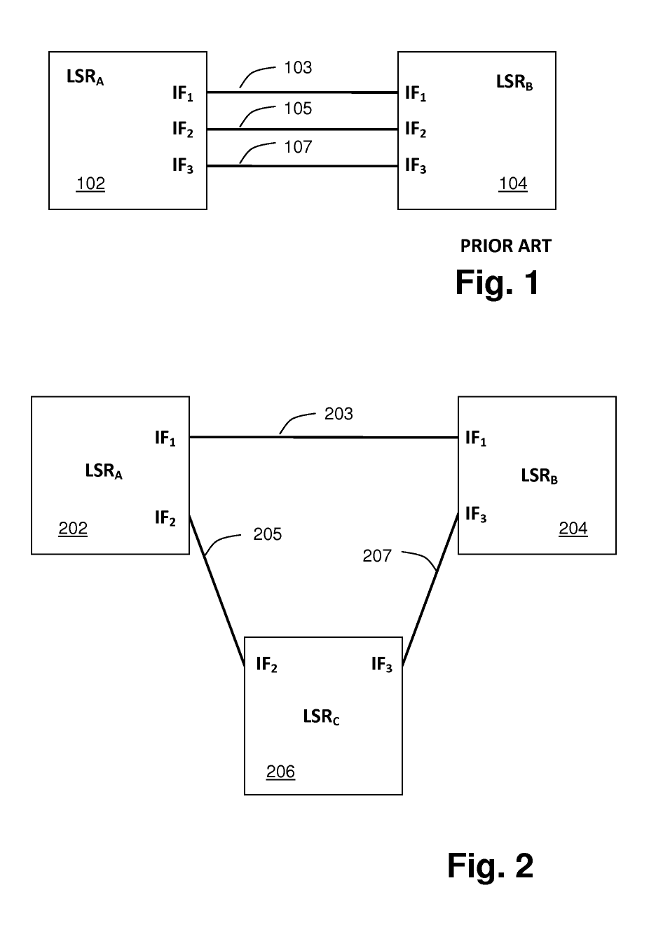

In this scenario there are three parallel link hello adjacencies between an LSR_{A} and LSR_{B}. Referring to FIG. 1 there may be seen Label Switched Router A (LSR_{A}) 102 and Label Switched Router B (LSR_{B}) 104 connected by three parallel links 103, 105, and 107. Tunnels are programmed between the LSRs, for example, in Equal Cost Multi-Path (ECMP) protocol fashion to establish these links. The links are not directly connected and switched through entities at lower network layers (Layer-1 and Layer-2). Thus it is possible that a failure on an intermediate underlying layer entity is detected asymmetrically by one of the peers.

In this scenario, assume that there is failure on link IF₁ 103 which detected first by LSR_{B} 104 but not LSR_{A} 102. LSR_{B} 104 brings down hello adjacency immediately. Since hello adjacencies continue to exist on IF₂ 105 and IF₃ 107, the LDP session remains up and operational. LSR_{A} 102 eventually detects loss of adjacency either by timing out the hello adjacency or by external methods such as Bidirectional Forwarding Detection (BFD) protocol, or other protocols such as G.8031/8032.

It is apparent that a notification message sent by LSR_{B} 104 to LSR_{A} 102 on detection of hello adjacency failure on IF₁ 103 using the existing session would expedite the failure detection at LSR_{A} 102, irrespective of the availability of external methods.

Scenario 2

In this scenario, as depicted in FIG. 2, two hello adjacencies are formed between LSR_{A} 202 and LSR_{B} 204. One is the link hello adjacency over link IF₁ 203 and another is the targeted hello adjacency between LSR_{A} 202 and LSR_{B} 204 via LSR_{C} 206.

For this scenario, assume that LSR_{A} 202 has established tunnel/FEC next-hops to both LSR_{B} 204 and LSR_{C} 206—either in ECMP or via LSR_{C} 206 having Loop Free Alternate (LFA) next-hop protecting LSR_{B} 204. Note that tunnel next-hops are resolved using link hello adjacency only. Thus on detection of link hello adjacency failure on IF₁ 203, LSR_{A} 202 can perform fast re-routing of traffic to LSR_{C} 206 via IF₂ 205 and IF₃ 207, and LSR_{B} 204 would withdraw the label from LSR_{A} 202 as there will be no more link hello adjacency between them.

Now assume that LSR_{B} 204 detects a failure of link hello adjacency over IF₁ 203 and LSR_{A} 202 has yet to detect the failure. The LDP session remains alive since the targeted hello adjacency is still intact by using the alternate path LSR_{A} 202 [symbol] LSR_{C} 206 [symbol] LSR_{B} 204.

Due to loss of link hello adjacency LSR_{B} 204 withdraws the labels for LDP FECs that are applicable only to link hello adjacencies which bring down the corresponding tunnels. Note that LDP label mapping exchanges are dependent on availability of types of adjacencies. The label withdrawal messages from LSR_{B} 204 arrives at LSR_{A} 202 before LSR_{A} 202 detects loss of hello adjacency. This race condition can result in an operational problem on implementing any Fast Re-Route (FRR) procedures at LSR_{A} 202 on failure of the adjacency. A label withdrawal is not considered as failure but rather as intent of LSR_{B} 204 for tearing down tunnels. However due to the hello adjacency failure, LSR_{A} 202 is expected to perform FRR of traffic to LSR_{C} 206.

A notification message sent by LSR_{B} 204 to LSR_{A} 202 upon detection of hello adjacency failure on IF₁ 203 using the existing session avoids such race conditions. According to an embodiment of the invention, with detection of hello adjacency failure, LSR_{B} 204 sends out a hello adjacency failure notification to LSR_{A} 202 before initiating the required label withdrawals. On processing the withdrawal notification, LSR_{A} 202 tears down adjacency and performs FRR before subsequent label withdrawals are processed.

The following section discloses a method of hello adjacency status notification in LDP agnostic to particular LDP protocol specifications.

LDP Interface Info TLV

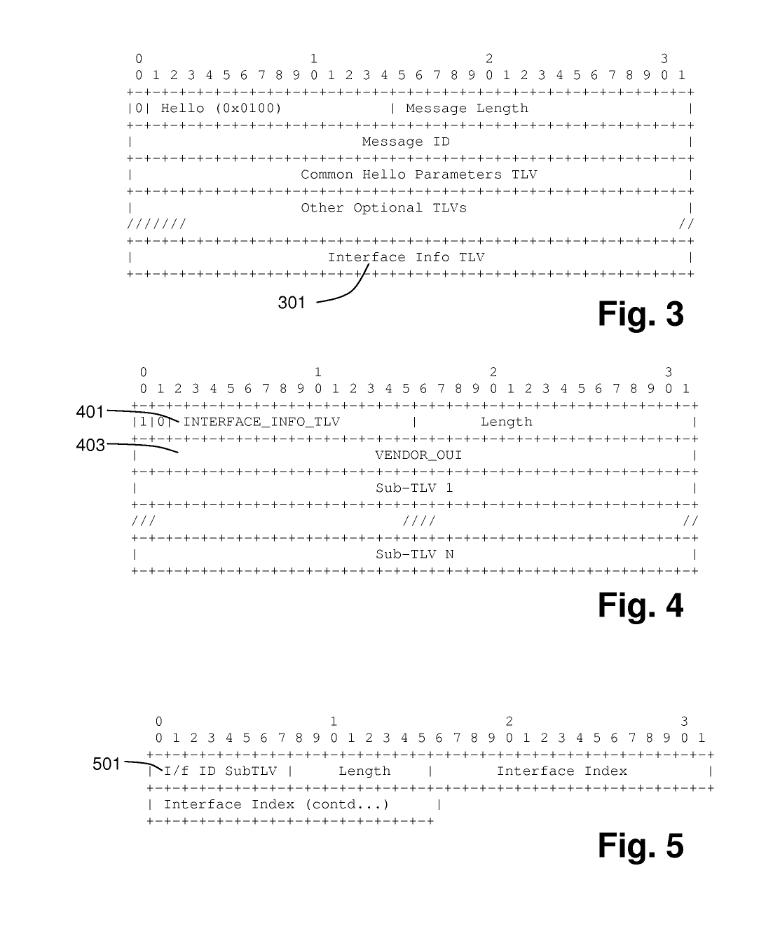

According to embodiments of the invention, there is defined an LDP Interface Info TLV to be sent when exchanging Hello Messages. Referring to FIG. 3 there may be seen a diagram illustrating a LDP Interface Info TLV 301 to be sent when exchanging Hello Messages according to an embodiment of the invention.

The TLV carries one or more Sub-TLVs. Referring to FIG. 4 there may be seen a diagram illustrating an Interface Info TLV 401 in a LDP Hello Message according to an embodiment of the invention.

The TLV type is to be assigned from Vendor Private TLV Code Space in the event that it is implemented as vendor proprietary. If defined as Private TLV then it carries the 4 byte VENDOR_OUI 403 which is assigned to the implementing Vendor.

In the event that the method is standardized then a code point needs to be assigned by IANA from LDP TLV space and VENDOR_OUI 403 is not needed.

Interface ID Sub-TLV

Referring to FIG. 5 there may be seen a diagram illustrating an Interface ID Sub-TLV 501 according to an embodiment of the invention. The following disclosure defines the Interface ID Sub-TLV with type 1.

The encoding of Interface ID Sub-TLV is as follows:

Interface ID Sub-TLV carries a 4 byte Identifier that uniquely identifies the Interface in the sender that has originated the Hello Message. The interface index MUST be unique to the sending LSR. This clause applies irrespective of whether the Interface is numbered or IPV4 unnumbered.

For Targeted Hellos the Interface ID MUST be set to 0. When Hellos are exchanged between peering LSRs over an Interface and adjacency is formed then each LSR learns the Interface ID assigned by peer.

LDP Adjacency Status TLV

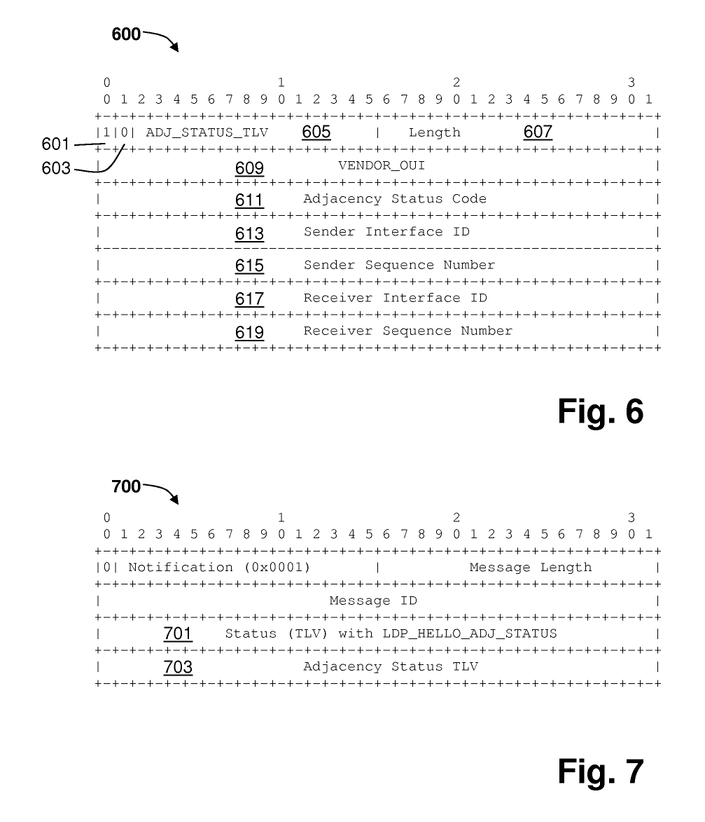

Referring to FIG. 6 there may be seen a diagram illustrating an Adjacency Status TLV 600 according to an embodiment of the invention. The following disclosure defines an Adjacency Status TLV to be sent with LDP Notification Message to notify status of Hello Adjacencies using the peering session.

The encoding of Adjacency Status TLV is as follows:

U Bit 601: The TLV Must be sent with U bit 1 to be ignored by receiver if unknown.

F Bit 603: The TLV MUST be sent with F bit 0.

Type 605: The TLV type is to be assigned from Vendor Private TLV Code Space if implemented as vendor proprietary. If defined as Private TLV then it carries the 4 byte VENDOR_OUI 609 which is assigned to the implementing Vendor.

If the method is standardized then a code point needs to be assigned by IANA from LDP TLV space and VENDOR_OUI 609 is not needed.

Length 607: 24 octets.

Vendor_OUI 609: IEEE assigned OUI of the implementing Vendor if the TLV is encoded as PRIVATE.

Adjacency Status Code 611:

The following status codes are defined.

ADJ_STATUS_UP=0

ADJ_STATUS_DOWN=1

ADJ_STATUS_UNKNOWN=2

Sender Interface ID 613: Interface ID of the Adjacency at sender for which Notification is sent. This Interface ID MUST be same as sent with Interface Info TLV in LDP Hellos originated by sender on respective interface.

Sender Sequence Number 615: An epoch number assigned for the Adjacency by Sender Node. This sequence number MUST be unique for adjacencies to the peer per Interface. A new epoch number MUST be assigned for each new adjacency formed on the interface with the peer.

Receiver Interface ID 617: Interface ID of the Adjacency at receiver for which Notification is sent. This Interface ID MUST be same as learnt from Interface Info TLV in LDP Hellos from the peering LSR.

Receiver Sequence Number 619: The epoch number assigned for the Adjacency by Sender Node. This sequence number is learnt from ADJ_STATUS_UP Notification sent by peering LSR.

FIG. 7 is a diagram illustrating an LDP Notification Message 700 for Hello Adjacency Status according to an embodiment of the invention.

The LDP Notification Message always carries the mandatory LDP_STATUS_TLV. A new LDP status code 701 is to be assigned as LDP_HELLO_ADJ_STATUS for Hello Adjacency Status Notification. It can be assigned from LDP Vendor Private Status Code space if implemented as proprietary method. If standardized then the status code needs to be assigned from LDP status code space by IANA.

This status code indicates that Notification Message is sent for notifying status of a hello adjacency. A message sent with LDP_HELLO_ADJ_STATUS MUST include an Adjacency Status TLV 703.

The following section discloses a method of hello adjacency status notification with respect to FIG. 2. According to the method LSR_{A} 202 and LSR_{B} 204 forms link hello adjacencies on interfaces IF₁ 203, IF₂ 205 and IF₃ 207 respectively.

The respective Interface IDs assigned by LSR_{A} 202 are:
IF₁-A,
IF₂-A,
IF₃-A.

The Sequence Numbers assigned by LSR_{A} 202 for respective adjacencies are:
Seq₁-A,
Seq₂-A and
Seq₃-A.

The respective Interface IDs assigned by LSR_{B} 204 are:
IF₁-B,
IF₂-B,
IF₃-B.

The Sequence Numbers assigned by LSR_{B} 204 for respective adjacencies are:
Seq₁-B,
Seq₂-B and
Seq₃-B.
A LSR that supports Adjacency Status Notification SHOULD send Interface Info TLV in Hello messages that carries the Interface ID associated with Hello Adjacencies to be formed by the Hello. Thus each LSR learns the Interface ID assigned by peering LSR for a Hello Adjacency.
The presence of Interface Info TLV received from a peer indicates that originating peer is capable of Adjacency Status Notification. Adjacency Status Notification can be exchanged only if both peering LSRs have exchanged Interface Info TLV in the Hello Adjacency. Further procedures disclosed below according to certain embodiments, assumes that both peering LSRs support Adjacency Status Notification.
If LSR_{A} 202 forms a Hello Adjacency on Interface IF₁ 203 after receiving a Hello from LSR_{B} 204 then LSR_{A} 202 SHOULD send Adjacency Status Notification with ADJ_STATUS_UP and the following info if the LDP session is in ESTABLISHED state:

Sender Interface ID: IF₁-A

Sender Sequence Number: Seq₁-A

Receiver Interface ID: IF₁-B

Receiver Sequence Number: Seq₁-B if LSR_{A} 202 had received ADJ_STATUS_UP from LSR_{B} 204 on IF₁ 203, else sets as 0.
When LSR_{B} 204 receives the Adjacency Status Notification from LSRA:
   If LSR_{B} 204 has not seen the Hello from LSR_{A} 202 on IF₁ 203 yet (thus no Hello Adjacency is formed by LSR_{B} 204 on IF₁ 203) then LSR_{B} 204 responds with Adjacency Status Notification to LSR_{A} 202 with ADJ_STATUS_UNKNOWN and following info:

Sender Interface ID: IF₁-B

Sender Sequence Number: 0

Receiver Interface ID: IF₁-A

Receiver Sequence Number: Seq₁-A.
If LSR_{B} 204 has already formed adjacency with LSR_{A} 202 on IF₁ 203 then:
LSR_{B} 204 checks that Sender Interface ID and Receiver Interface ID matches to what was negotiated in Hello Message. If not then LSR_{B} 204 drops the Adjacency Status Notification. If notification is accepted then LSR_{B} 204 records the Sender Sequence Number in the hello adjacency.
LSR_{B} 204 checks if it had sent Adjacency Status Notification to LSR_{A} 202 with ADJ_STATUS_UP on IF₁ 203. It is possible that LSR_{B} 204 had sent Adjacency Status Notification to LSR_{A} 202 with ADJ_STATUS_UP on IF₁ 203 before but LSR_{A} 202 had returned as ADJ_STATUS_UNKNOWN. In that case LSR_{B} 204 resends ADJ_STATUS_UP notification now, and thus the hand shake is complete on the adjacency state with local and remote sequence numbers.
If LSR_{A} 202 receives ADJ_STATUS_UNKNOWN from LSR_{B} 204 in response to ADJ_STATUS_UP sent earlier then LSR_{A} 202 records as if no ADJ_STATUS_UP has been sent to LSR_{B} 204. LSR_{A} 202 would resend ADJ_STATUS_UP to LSR_{B} 204 upon receipt of ADJ_STATUS_UP from LSR_{B} 204.
If LSR_{A} 202 receives ADJ_STATUS_UP from LSR_{B} 204 then LSR_{A} 202 records the Sequence Number assigned by LSR_{B} 204 on the adjacency and thus hand shake is complete on the adjacency state with local and remote sequence numbers.
If LSR_{A} 202 detects failure of Hello Adjacency with LSR_{B} 204 on IF₁ 203, then LSR_{A} 202 sends Adjacency Status Notification to LSR_{B} 204 with ADJ_STATUS_DOWN and following info:

Sender Interface ID: IF₁-A

Sender Sequence Number: Seq₁-A

Receiver Interface ID: IF₁-B

Receiver Sequence Number: Seq₁-B
Upon receipt of the ADJ_STATUS_DOWN notification from LSR_{A} 202, LSR_{B} 204 checks that the following items matches what was negotiated during handshake:

Sender Interface ID

Sender Sequence Number

Receiver Interface ID

Receiver Sequence Number

If the items do not match, then LSR_{B} 204 drops the notification message. If the items do match, then LSR_{B} 204 immediately brings down adjacency on IF₁ 203.

Therefore what has been disclosed is a method for hello adjacency status notification between two LDP peers using the operation LDP session. The method allows for an LDP peer to undertake appropriate responsive action to a hello adjacency failure detected by the other peer, including, for example, diverting traffic to alternate links and implementing Fast Re-Routing (FRR) techniques.

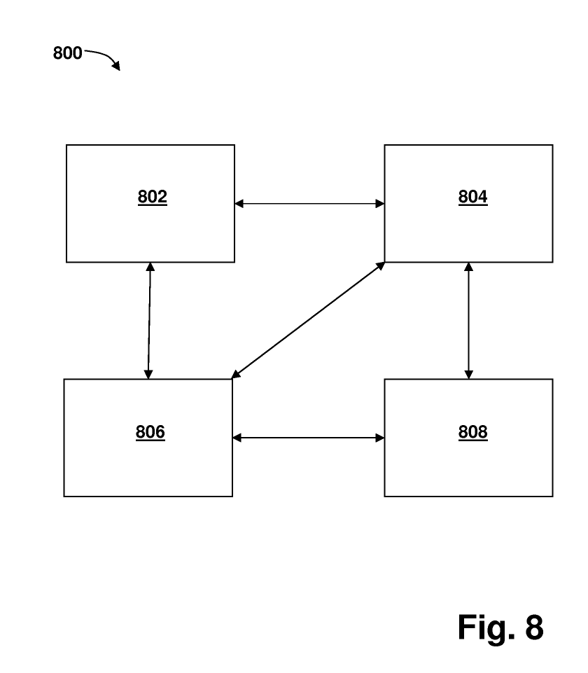

Referring now to FIG. 8, a network equipment processor assembly 800 which in certain embodiments may be used in the handling of packets, includes a network equipment processor element 806 (e.g., a central processing unit (CPU) and/or other suitable processor(s)), a memory 808 (e.g., random access memory (RAM), read only memory (ROM), and the like), a cooperating module/process 802, and various input/output devices 804 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in hardware, for example using one or more application specific integrated circuits (ASIC), and/or any other hardware equivalents. Alternatively, according to one embodiment, the cooperating process 802 can be loaded into memory 808 and executed by network equipment processor 806 to implement the functions as discussed herein. As well, cooperating process 802 (including associated data structures) can be stored on a tangible, non-transitory computer readable storage medium, for example magnetic or optical drive or diskette, semiconductor memory and the like.

It is contemplated that some of the steps discussed herein as methods may be implemented within hardware, for example, as circuitry that cooperates with the network equipment processor to perform various method steps. Portions of the functions/elements described herein may be implemented as a computer program product wherein computer instructions, when processed by a network equipment processor, adapt the operation of the network equipment processor such that the methods and/or techniques described herein are invoked or otherwise provided. Instructions for invoking the inventive methods may be stored in fixed or removable media, and/or stored within a memory within a computing device operating according to the instructions.

Note, in the preceding discussion a person of skill in the art would readily recognize that steps of various above-described methods can be performed by appropriately configured network processors. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices are all tangible and non-transitory storage media and may be, e.g., digital memories, magnetic storage media such as a magnetic disks and magnetic tapes, hard drives, or optically readable digital data storage media. The embodiments are also intended to cover network element processors programmed to perform said steps of the above-described methods.

Numerous modifications, variations and adaptations may be made to the embodiment of the invention described above without departing from the scope of the invention, which is defined in the claims.

What is claimed is:

1. A method for Label Distribution Protocol (LDP) Hello Adjacency status synchronization, the method comprising:
generating, by a first packet-switched network node, a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV; and
transmitting, by the first packet-switched network node, the Hello Adjacency Status TLV to a second packet-switched network node.

2. The method of claim 1, wherein the Hello Adjacency Status TLV is included within an LDP Hello Status message.

3. The method of claim 2, wherein the LDP Hello Status message is sent from an ingress node to a transit node.

4. The method of claim 2, wherein the LDP Hello Status message is sent from a first transit node to a second transit node.

5. The method of claim 2, wherein the status data field further comprises an Adjacency Status Code field; a Sender Interface ID field; a Sender Sequence Number field; a Receiver Interface ID field; and a Receiver Sequence Number field.

6. The method of claim 2, wherein the U bit comprises a value of one; and the F bit comprises a value of zero; in the case when the Hello Adjacency Status TLV is included within an LDP Hello Status message.

7. The method of claim 2, wherein the Hello Adjacency Status TLV further comprises a Vendor_OUI field.

8. An apparatus for Label Distribution Protocol (LDP) Hello Adjacency status synchronization, the apparatus comprising:
a processor; and
a tangible and non-transitory computer readable storage medium storing programming for execution by the processor, the programming including instructions to:
communicate a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV.

9. The apparatus of claim 8, wherein the Hello Adjacency Status TLV is communicated within an LDP Hello Status message.

10. The apparatus of claim 9, wherein the LDP Hello Status message is sent to a transit node.

11. The apparatus of claim 9, wherein the status data field further comprises an Adjacency Status Code field; a Sender Interface ID field; a Sender Sequence Number field; a Receiver Interface ID field; and a Receiver Sequence Number field.

12. The apparatus of claim 9, wherein the U bit comprises a value of one; and the F bit comprises a value of zero; in the case when the Hello Adjacency Status TLV is included within an LDP Hello Status message.

13. The apparatus of claim 9, wherein the Hello Adjacency Status TLV further comprises a Vendor_OUI field.

14. A method for Label Distribution Protocol (LDP) Hello Adjacency status synchronization, the method comprising:
receiving, a second packet-switched network node from by a first packet-switched network node, a Hello Adjacency Status type-length-value (TLV) comprising adjacency status specific data, wherein the Hello Adjacency Status TLV comprises an unknown (U) bit, a forwarding (F) bit, a type field indicating a Hello Adjacency Status type, a length field, and a status data field comprising the status specific data, wherein the status specific data comprises information about Hello Adjacency status, the U bit indicates how to respond to an unknown received TLV, the F bit indicates whether to forward the unknown received TLV, and the length field indicates a length of the Hello Adjacency Status TLV; and
decoding, by the second packet-switched network node, the Hello Adjacency status.

15. The method of claim 14, wherein the Hello Adjacency Status TLV is included within an LDP Hello Status message.

16. The method of claim 15, wherein the LDP Hello Status message is received at a transit node from an ingress node.

17. The method of claim 15, wherein the LDP Hello Status message is received at a second transit node from a first transit node.

18. The method of claim 15, wherein the status data field further comprises an Adjacency Status Code field; a Sender Interface ID field; a Sender Sequence Number field; a Receiver Interface ID field; and a Receiver Sequence Number field.

19. The method of claim 15, wherein the U bit comprises a value of one; and the F bit comprises a value of zero; in the case when the Hello Adjacency Status TLV is included within an LDP Hello Status message.

20. The method of claim 15, wherein the Hello Adjacency Status TLV further comprises a Vendor_OUI field.
